(19) United States
(12) Patent Application Publication
(10) Pub. No.: US 2026/0336113 A1
(43) Pub. Date: Oct. 29, 2026

(54) Motion Planning with Momentum Minimization for Underactuated Robots

(71) Applicant: Southwest Research Institute, San Antonio, TX (US)

(72) Inventors: Michael Ripperger, San Antonio, TX (US); Meera M. Day Towler, San Antonio, TX (US); Lily Bay-Wallace, San Antonio, TX (US)

(21) Appl. No.: 19/190,973

(22) Filed: Apr. 28, 2025

(51) Int. Cl. B25J 9/16

(52) U.S. Cl. CPC B25J 9/1664; B25J 9/1635; B25J 9/1653

(57) ABSTRACT

A motion planning system for planning the motion of a robotic arm of a robotic system. A seed motion process provides a proposed motion of the robotic arm. A motion planning process uses a set of costs and a set of constraints to mathematically optimize the proposed motion, with the set of costs having a momentum cost of motion of the robotic arm. Data for the momentum cost is provided by a momentum estimation process that simulates the proposed motion and generates momentum data. Using this data and other cost and constraint data, the motion planning process refines the proposed motion, thereby generating trajectory data, and provides the trajectory data to the robotic control system.

### BACKGROUND OF THE INVENTION

Robots have long used pre-planned motions to perform highly structured and repetitive tasks in applications such as automotive manufacturing or electronics assembly. However, dynamic motion generation is required to operate robots in previously unknown or changing environments or when performing novel tasks.

Dynamic robot motion generation aims to find a collision-free path in a robot configuration space to reach a desired goal pose from a starting configuration. This path is often subject to various additional motion constraints and seeks to minimize a variety of user-defined costs. Various sensor data (e.g., depth images, point clouds) can also be integrated into the motion planning process to create a representation of the perceived environment for navigation and collision avoidance. The motion generation is “dynamic” in the sense that the environment changes over time.

Functionally, a robot motion path is a set of piecewise-continuous positions, velocities, and accelerations that each joint of the robot should move through to accomplish a given task. A robot's “trajectory” refers to a path plus a schedule in time; the trajectory informs a robot when it should be at what point along the path.

Many motion planning algorithms utilize numerical optimization to produce robot trajectories. Given costs and constraints and an initial trajectory guess, these optimization-based motion planners can produce robot trajectories that meet user-defined constraints while minimizing user-defined costs. Two example optimization-based methods are direct collocation and kinematic trajectory optimization.

### BRIEF DESCRIPTION OF DRAWINGS

FIG. 1 illustrates a satellite having a robotic arm and motion planning process in accordance with the invention.

FIG. 2 is a plot of the magnitude of linear and angular momentum resulting from a robotic arm trajectory performed without momentum as a cost in motion planning optimization.

FIG. 3 is a plot of the magnitude of linear and angular momentum resulting from a robotic arm trajectory performed from the same seed trajectory as FIG. 2 but with momentum used as an additional cost during motion planning optimization.

### DETAILED DESCRIPTION OF THE INVENTION

The following description is directed to a recognition that in the context of space robotics, motion planning must account for the momentum imparted by the motion of a robotic arm since the entire system is free-floating in space. Most satellites are equipped with thrusters and momentum wheels which generate linear and angular momentum, respectively, to allow the satellite to control its position and orientation, respectively. However, when a satellite-mounted robot arm moves—even at relatively low speeds—its motion generates more momentum (and at a faster rate) than these systems have capacity to counteract. The result is that the motion of the robot changes the position and orientation of the satellite, which in turn creates two problems. First, the frame of reference of the robotic task is changed because the satellite itself moved in response to the robot motion, necessitating re-planning of the robot motion. This causes an infinite loop of satellite position disturbance and replanning that cannot be fixed by traditional closed-loop control methods. Second, the attitude and orbit control systems of the satellite must ultimately expend energy to correct the position and orientation change imparted by the motion of the robot. Both these problems are especially true when the robot arm has similar mass relative to the satellite to which it is mounted.

In the embodiment of this description, the method and system of the invention implement direct collocation motion planning. However, the method and system may be implemented with other optimization motion planning methods, in which, among other costs and constraints, the momentum generated by execution of the trajectory is minimized.

In direct collocation, a continuous-time motion planning problem is converted into a programming problem by approximating the robot's state trajectory and control input trajectory using piecewise polynomials. This effectively “collocates” the dynamics at specific points along the trajectory to ensure accuracy while optimizing the overall motion. The trajectory is solved in advance. Thus, as used herein, “direct collocation” is an optimization technique that simulates system dynamics to optimize a system control input trajectory and a system state trajectory (i.e., joint torques and joint positions/velocities, respectively).

Direct collocation is dependent on receiving a good seed trajectory. A “seed trajectory” in the context of optimization-based based motion planning refers to an initial guess for the state and control input variables that are used as a starting point for the optimization process. In other words, the seed trajectory is a rough initial path that the optimization algorithm refines to find the optimal trajectory.

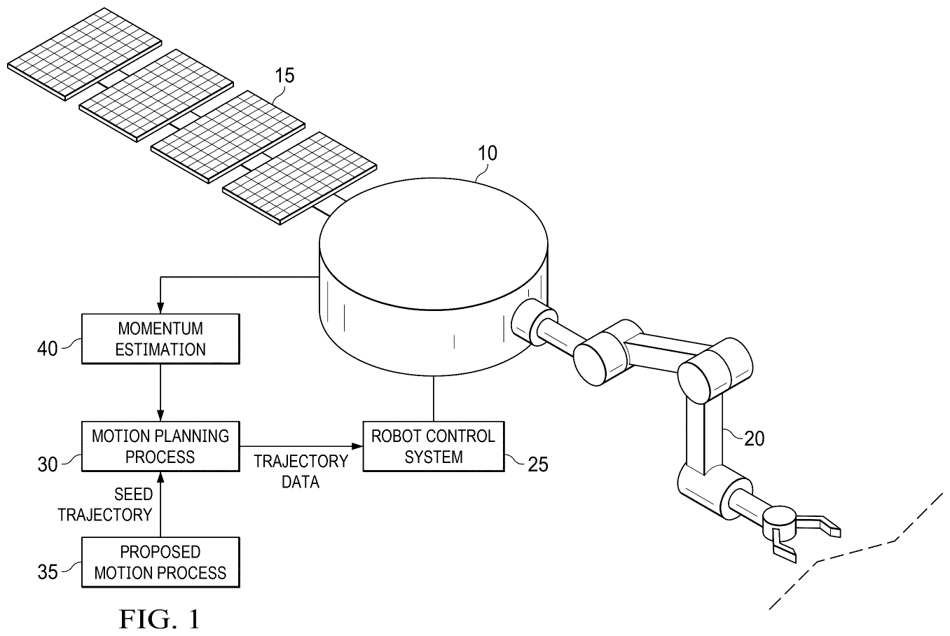

FIG. 1 illustrates a satellite 10 having a robotic arm 20, whose trajectory is planned by a motion planning system having a motion planning process 30 in accordance with the invention. It is assumed that motion planning process 30 has appropriate hardware and software to receive input data and generate trajectory data as described herein. Likewise, the other processes described herein are assumed to have appropriate software and hardware.

Although motion planning process 30 is especially suited for a robot arm in space, motion planning process 30 is suitable for any underactuated robotic system in which the actuated joints of the robot cannot fully control the position and orientation of the full system. In addition to space environments, underactuated systems are used in most legged robotics applications and for various types of logistics tasks where the payload of the robot cannot be fully manipulated. In the example of this embodiment, the satellite 10 is the “robotic system” upon which the robotic arm 20 induces momentum.

Satellite 10 may serve a wide array of purposes and may carry other payload in addition to robotic arm 20. It typically carries a solar panel array 15, which converts sunlight into electricity, providing a power source for its operations.

Robotic arm 20 may be any one of known programmable mechanical arms capable of performing tasks such as lifting, moving, and placing objects. For space applications, it may serve any one or more of various functions, such as on-orbit servicing, assisting in deploying payloads, servicing other satellites, or space debris removal.

Whether attached to a satellite or to some other underactuated robotic system, as is typical, robotic arm 20 has multiple jointed segments that allow it to grasp and move objects or perform other manipulations of a tool, sensor, or workpiece with a number of degrees of freedom. The characteristics of its joint motions are often referred to as its “kinematics”.

The robotic system has a control system 25 uses a combination of hardware and software to translate commands into precise movements. Relevant to the invention described herein, control system 25 receives trajectory data from motion planning process 30, which control system 25 uses to implement the planned trajectory.

As explained above, a feature of the invention is the recognition that the motion of robotic arm 20 induces undesired momentum (and consequently position and orientation change) on satellite 10 or on whatever other underactuated system to which it may be attached. It is desired to minimize this undesired induced momentum.

A momentum estimation process 40 may use known methods to determine this momentum. Typically, the momentum is measured at the base of robotic arm 20, i.e., at the point where robotic arm 20 is attached to satellite 10. Various direct and indirect measurements may be made to determine the mass and velocity factors of momentum. The momentum estimation process 40 may receive proposed motions from process 35 and simulate them to calculate momentum. This momentum value is provided to motion planning process 30.

Motion planning process 30 implements a mathematical optimization process to plan a trajectory for robotic arm 20. The motion planning process uses the momentum value from momentum estimation process 40 to optimize proposed motions, such that the optimization minimizes the total momentum generated (among other costs and constraints). Once the planning is complete, a trajectory is sent to robot control system 25, which executes the trajectory.

The optimization process is based on a set of costs and constraints for the desired motion of the robot. In the example of this description, motion planning process 30 is a direct collocation process that produces two trajectories: a state trajectory and a control input trajectory. However, other and/or additional motion planning methods may be used, such as kinematic trajectory optimization. Also, as described below, a kinematic optimization process may be used to generate the seed trajectory for the direct collocation process.

The state trajectory is the output of the direct collocation algorithm and represents the optimal sequence of joint positions that the robot should move through throughout the trajectory. The control input trajectory defines the torque that needs to be applied to each joint of the robot to achieve the optimal positions defined in the state trajectory.

In order for the optimization process to run, both the state and control input trajectories use an initial guess (“seed trajectory”) that the optimization process drives to optimal values. Costs and constraints are applied to the control input trajectory and the state trajectory in direct collocation to produce the desired system behavior. A proposed motion process 35 generates the seed trajectory. Process 35 may use direct collocation methods or other motion planning methods, such as a kinematic trajectory planning process, to generate the seed trajectory.

In addition to momentum of the robotic system, examples of costs to a motion planning process 30 are: final time (to minimize the execution time of the trajectory); running torque cost (to minimize the amount of energy required). The following are examples of constraints to be applied: equal time intervals between waypoints in the trajectory; joint limits (position, velocity, force/torque); collision avoidance; state position/velocity (for constraining the start and/or end state to specific values); Cartesian target position (for constraining the tool center point [TCP] of the start and/or end state to a specific location). Various sensors and estimation processes may be used to directly measure or estimate costs and constraints.

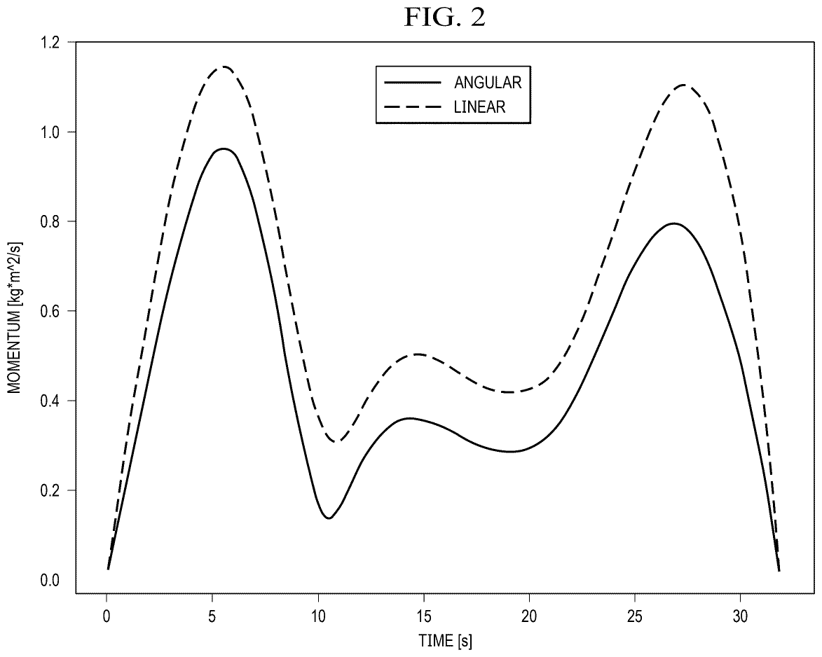

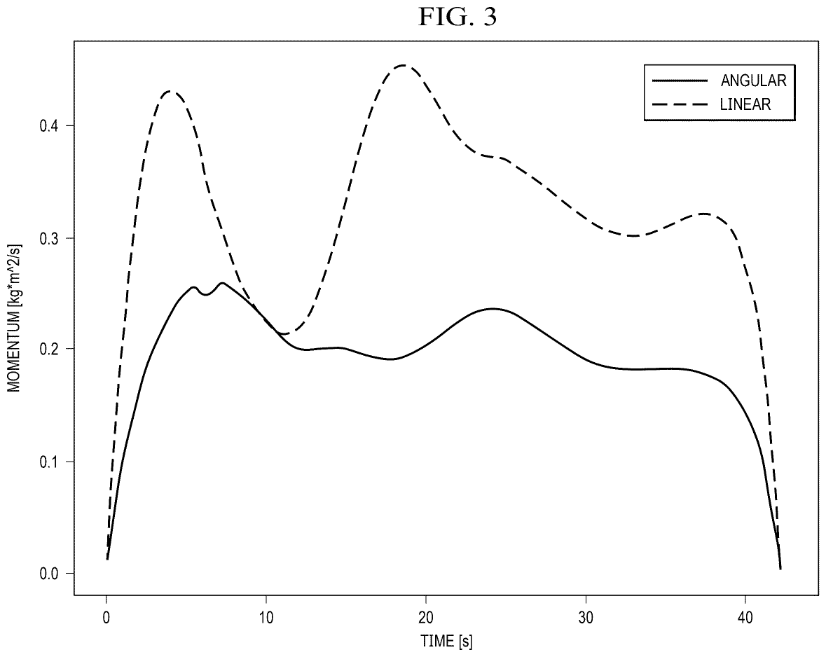

FIGS. 2 and 3 are plots that compare the magnitude of linear and angular momentum generated by a robotic system in execution of a trajectory without momentum minimization (FIG. 2) and with momentum minimization (FIG. 3).

In the examples of FIGS. 2 and 3, a kinematic trajectory optimization motion process was used to generate the seed trajectory for a direct collocation optimization motion planning process. FIG. 2 shows the momentum of the trajectory output of the direct collocation optimization motion planning without using momentum minimization. FIG. 3 shows the momentum of a trajectory generated from the same seed trajectory as FIG. 2, but with a momentum minimization cost implemented during the direct collocation motion planning process. For the trajectory of FIG. 3, motion planning process 30 has penalized motions that result in high momentum.

The maximum momentum generated over the course of the trajectory of FIG. 2 is less than 50% of the maximum generated in execution of the trajectory of FIG. 3. The execution time of the momentum-minimized trajectory is longer than the seed—as the naïve assumption that slower motions induce less momentum would suggest—and is only 130% of the seed execution time.

In sum, the momentum effect of robotic arm 20 is computed and integrated as a cost into motion planning process 30. In this manner, motion planning process 30 uses a momentum-aware cost that minimizes the momentum generated by execution of the seed trajectory.

As indicated above, motion planning process 30 with momentum as an added cost may use optimization methods other than direct collocation. Also, one optimization process can be used to generate input (as a seed trajectory) to another. For example, in other embodiments, momentum as a cost among other costs and constraints, could be used with a kinematic trajectory optimization process to implement motion planning process 30 with a seed trajectory being provided by that approach or some other approach to implement proposed motion process 25.

1. A motion planning system for planning the motion of a robotic arm attached to a robotic system, the robotic system having a robotic control process, comprising:
a seed motion process for providing a proposed motion of the robotic arm;
a motion planning process for using a set of costs and a set of constraints to mathematically optimize the proposed motion, the set of costs having at least a momentum cost of motion of the robotic arm upon the robotic system;
a momentum estimation process for simulating the proposed motion and generating momentum cost data for use by the motion planning process;
wherein the motion planning process refines the proposed motion using the momentum cost data and other cost and constraint data, thereby generating trajectory data, and provides the trajectory data to the robotic control system.

2. The motion planning system of claim 1, wherein the motion planning process implements a direct collocation motion planning method.

3. The motion planning system of claim 1, wherein the motion planning process implements a kinematic trajectory motion planning method.

4. The motion planning system of claim 1, wherein the seed motion process uses a kinematic trajectory motion planning method to generate the proposed motion.

5. The motion planning process of claim 1, wherein the robotic arm is attached to a satellite in space and the momentum estimation process determines momentum where the robotic arm is attached to the satellite.

6. The motion planning process of claim 1, wherein the robotic arm is attached to a legged robotic system.

7. A method for planning the motion of a robotic arm of a robotic system, the robotic system having a robotic control system, comprising:
providing a proposed motion of the robotic arm;
simulating the proposed motion to determine the momentum effect of the proposed motion on the robotic system, thereby generating momentum data;
using a motion planning process with a set of costs and a set of constraints to mathematically optimize the proposed motion;
wherein the set of costs has at least a momentum cost of motion of the robotic arm;
wherein the motion planning process refines the proposed motion using the momentum cost data and other cost and constraint data, thereby generating trajectory data, and provides the trajectory data to the robotic control system.

8. The method of claim 7, wherein the motion planning process implements a direct collocation motion planning method.

9. The method of claim 7, wherein the motion planning process implements a kinematic trajectory motion planning method.

10. The method of claim 7, wherein the seed motion process uses a kinematic trajectory motion planning method to generate the proposed motion.

11. The method of claim 7, wherein the robotic arm is attached to a satellite in space and the momentum estimation process determines momentum where the robotic arm is attached to the satellite.

12. The method of claim 7, wherein the robotic arm is attached to a legged robotic system.
